(19) United States
(12) Patent Application Publication
(10) Pub. No.: US 2023/0162303 A1
(43) Pub. Date: May 25, 2023

(54) INFORMATION PROCESSING APPARATUS, INFORMATION PROCESSING METHOD, AND STORAGE MEDIUM

(71) Applicant: ANIFIE, INC., Irvine, CA (US)

(72) Inventors: Yohei IWASAKI, Irvine, CA (US); Claudio Jesus TORRES, Barcelona (ES)

(21) Appl. No.: 18/056,512

(22) Filed: Nov. 17, 2022

Related U.S. Application Data
(60) Provisional application No. 63/281,240, filed on Nov. 19, 2021.

(51) Int. Cl. G06Q 50/18; G06Q 20/14

(52) U.S. Cl. CPC G06Q 50/184; G06Q 20/14

(57) ABSTRACT

An information processing apparatus includes: a first identifier acquiring unit that acquires two or more first identifiers for respectively identifying two or more pieces of primary content that were used to create secondary content created using the two or more pieces of primary content; a second identifier acquiring unit that acquires a second identifier for identifying the secondary content; a copyright information configuring unit that configures hierarchical copyright information containing the two or more first identifiers acquired by the first identifier acquiring unit and the second identifier acquired by the second identifier acquiring unit; and a management processing unit that performs management processing for managing the hierarchical copyright information configured by the copyright information configuring unit, in association with the secondary content.

### CROSS-REFERENCE TO RELATED APPLICATIONS

This non-provisional application claims priority to U.S. Provisional Patent Application 63/281,240, filed Nov. 19, 2021, the entire disclosure of which is incorporated herein by reference.

### TECHNICAL FIELD

The present invention relates to an information processing apparatus or other suitable apparatuses for processing information on content rights.

### BACKGROUND ART

Conventionally, there exists a unique digital identifier referred to as a non-fungible token (NFT) produced through the use of blockchain technologies (see Non-Patent Document 1, for example).

### CITATION LIST

### Non-Patent Document

Non-Patent Document 1: “A Thorough Explanation of What NFT is from Basics and Why Digital Data is Worth Hundreds of Millions of Dollars”, [online], [accessed on Nov. 8, 2021], Internet [https://www.sbbit.jp/article/fj/60992]

### SUMMARY OF THE INVENTION

Technical Problem

Using existing technologies, no mechanism exists to properly manage a relationship between secondary content and two or more pieces of primary content from which the secondary content was created.

### Solution to the Problem

A first aspect of the present invention is directed to an information processing apparatus including: a first identifier acquiring unit that acquires two or more first identifiers for respectively identifying two or more pieces of primary content that were used to create secondary content created using the two or more pieces of primary content; a second identifier acquiring unit that acquires a second identifier for identifying the secondary content; a copyright information configuring unit that configures hierarchical copyright information containing the two or more first identifiers acquired by the first identifier acquiring unit and the second identifier acquired by the second identifier acquiring unit; and a management processing unit that performs management processing for managing the hierarchical copyright information configured by the copyright information configuring unit, in association with the secondary content.

By utilizing this first configuration, it is possible to provide a mechanism for properly managing a relationship between secondary content and two or more pieces of primary content from which the secondary content was created.

A second aspect of the present invention is directed to the information processing apparatus according to the first aspect, wherein the hierarchical copyright information is a non-fungible token.

By utilizing this second configuration, it is possible to provide a mechanism for properly managing a relationship between secondary content and two or more pieces of primary content from which the secondary content was created, using the non-fungible token.

A third aspect of the present invention is directed to the information processing apparatus according to the first or second aspect, further including: an operation information receiving unit that receives an editing instruction regarding two or more pieces of primary content that are used to create the secondary content; and a payment processing unit that performs payment processing for paying a fee to one or more subjects among an author and an owner corresponding to the two or more first identifiers of the respective two or more pieces of primary content corresponding to the editing instruction received by the operation information receiving unit, the first identifiers being acquired by the first identifier acquiring unit.

By utilizing this third configuration, the relationship between secondary content and two or more pieces of primary content from which the secondary content was created is properly managed, and thus it is possible to pay a proper fee to an author or an owner of the primary content that was used to create the secondary content.

A fourth aspect of the present invention is directed to the information processing apparatus according to the first or second aspect, further including: an operation information receiving unit that receives a sales instruction to sell secondary content, the sales instruction corresponding to a second identifier for identifying the secondary content; and a payment processing unit that acquires the second identifier corresponding to the sales instruction received by the operation information receiving unit, acquires two or more first identifiers that are paired with the second identifier, from the hierarchical copyright information corresponding to the second identifier, and performs payment processing for paying a fee to one or more subjects among an author and an owner corresponding to the two or more first identifiers and one or more subjects among an author and an owner corresponding to the second identifier.

By utilizing this fourth configuration, it is possible to properly distribute the fee for the sale of the secondary content.

A fifth aspect of the present invention is directed to the information processing apparatus according to the third aspect, wherein the payment processing unit includes: a fee acquiring element that acquires fees to the respective two or more subjects, using one or more of hierarchy information indicating whether the two or more subjects are subjects of the primary content or subjects of the secondary content, and degrees of contribution by the subjects in the secondary content; and a payment processing element that performs payment processing using the fees to the respective two or more subjects acquired by the fee acquiring element.

By utilizing this fifth configuration, the relationship between secondary content and primary content from which the secondary content was created is properly managed, and thus it is possible to pay a more proper fee to an author or an owner for the sale of the secondary content.

A sixth aspect of the present invention is directed to the information processing apparatus according to any one of the first to fifth aspects, further including an editing unit that creates the secondary content in response to an editing instruction to create the secondary content using the two or more pieces of primary content, wherein the editing unit refers to a condition storage unit in which editability conditions respectively associated with two or more pieces of primary content are stored, and creates the secondary content according to the editing instruction within a range allowed by the editability conditions respectively corresponding to the two or more pieces of primary content.

By utilizing this sixth configuration, it is possible to properly use content by managing editability conditions according to the content.

A seventh aspect of the present invention is directed to the information processing apparatus according to the sixth aspect, wherein each of the editability conditions is one condition in a condition group including two or more conditions “use-as-is only”, “up to change of attribute value”, and “free”.

By utilizing this seventh configuration, it is possible to properly use content by managing proper editability conditions according to the content.

Furthermore, an eighth aspect of the present invention is directed to the information processing apparatus according to the sixth or seventh aspect, wherein the fees for the two or more pieces of primary content are different according to the editing instruction.

By utilizing this eighth configuration, it is possible to pay a proper fee according to the editing content, to a copyright holder.

A ninth aspect of the present invention is directed to the information processing apparatus according to any one of the first to eighth aspects, wherein the hierarchical copyright information contains author information for specifying an owner of an author's property right, transfer date information for specifying the date of transfer of the right, fee information for specifying a fee at the time of transfer of the right, application destination information for specifying an application destination of content, or application source information for specifying an application source of content.

By utilizing this ninth configuration, it is possible to provide a mechanism for properly managing a relationship between secondary content and two or more pieces of primary content from which the secondary content was created.

A tenth aspect of the present invention is directed to the information processing apparatus according to any one of the first to ninth aspects, wherein the management processing unit registers the hierarchical copyright information in a blockchain in association with the secondary content.

By utilizing this tenth configuration, it is possible to register hierarchical copyright information corresponding to authentic secondary content, in a blockchain.

### Advantageous Features of the Invention

In accordance with the information processing apparatus and method of the present invention, it is possible to provide a mechanism for properly managing a relationship between secondary content and two or more pieces of primary content from which the secondary content was created.

### BRIEF DESCRIPTION OF THE DRAWINGS

FIG. 1 is a conceptual diagram of an information system A in Preferred Embodiment 1.

FIG. 2 is a block diagram of the information system A in the preferred embodiment.

FIG. 3 is a flowchart illustrating an operation example of an information processing apparatus 1 in the preferred embodiment.

FIG. 4 is a flowchart illustrating an operation example of the information processing apparatus 1 in the preferred embodiment.

FIG. 5 is a flowchart illustrating an example of copyright information configuring processing in the preferred embodiment.

FIG. 6 is a flowchart illustrating an example of lower-level content information acquiring processing in the preferred embodiment.

FIG. 7 is a flowchart illustrating an example of application destination information adding processing in the preferred embodiment.

FIG. 8 is a flowchart illustrating an example of payment processing in the preferred embodiment.

FIG. 9 is a flowchart illustrating an example of sales processing in the preferred embodiment.

FIG. 10 is a schematic view of a computer system in the preferred embodiment.

FIG. 11 is a block diagram of the computer system in the preferred embodiment.

FIG. 12 is a block diagram of an information processing apparatus 4 in the preferred embodiment.

### DESCRIPTION OF THE PREFERRED EMBODIMENT

Below, a preferred embodiment of the information processing apparatus and its components and variants will be described with reference to the drawings. The constituent elements denoted by the same reference numerals in the embodiments described below perform similar operations, and thus a description thereof may not be repeated.

### Preferred Embodiment 1

In this preferred embodiment, an information processing apparatus will be described that acquires second copyright information corresponding to secondary content created using one or more pieces of primary content corresponding to first copyright information, acquires first identifiers for respectively specifying the one or more pieces of primary content, acquires hierarchical copyright information containing the second copyright information and the one or more first identifiers, and performs management processing for managing the hierarchical copyright information in association with the secondary content. The management processing and payment processing described below are preferably performed using a blockchain mechanism. The information processing apparatus is independent of the blockchain.

Furthermore, in this embodiment, an information processing apparatus will be described that performs payment processing for paying a fee for an operation on primary content that was used to create secondary content, to an author or an owner of the primary content.

Furthermore, in this embodiment, an information processing apparatus will be described that performs payment processing for paying a fee for sale of secondary content, not only to an author or an owner of the secondary content but also to an author or an owner of primary content.

Furthermore, in this embodiment, an information processing apparatus 1 will be described in which an editability condition that is applied when using primary content is managed for each piece of primary content, the information processing apparatus being allowed to use primary content within a range allowed by the editability condition, in the case of creating secondary content using the primary content.

Furthermore, in this embodiment, an information processing apparatus will be described in which the usage fees of primary content are different according to how the primary content is used to create secondary content.

In this embodiment, the state in which information XX is associated with information YY means that the information YY can be acquired from the information XX or the information XX can be acquired from the information YY, and there is no limitation on the method for associating the information. The information XX and the information YY may be linked to each other or in the same buffer. The information XX may be contained in the information YY, or the information YY may be contained in the information XX, for example.

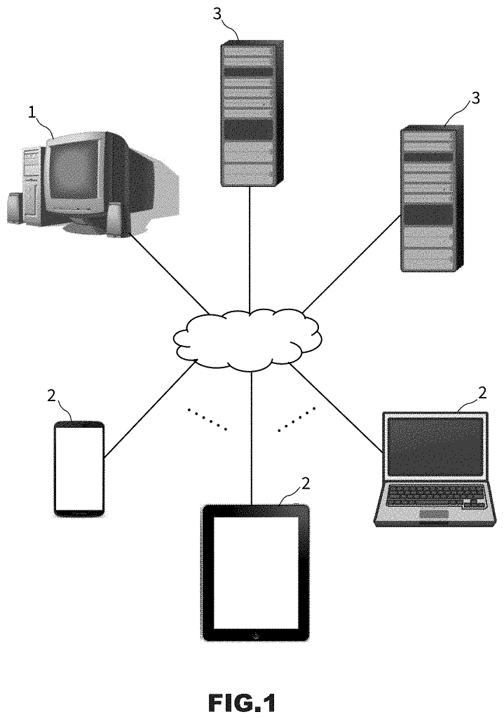

FIG. 1 is a conceptual diagram of an information system A in this embodiment. The information system A includes an information processing apparatus 1, one or more terminal apparatuses 2, and two or more servers 3. The two or more servers 3 are Peer-To-Peer (P2P) networks, for example. The P2P networks may be denoted by 3.

The information processing apparatus 1 is an apparatus that performs management processing for managing hierarchical copyright information in association with secondary content. The information processing apparatus 1 is typically referred to as a server, such as a cloud server, an application service provider (ASP) server, for example. Alternately, any other suitable type of information processing apparatus may be used. There is no limitation on the type of the information processing apparatus 1.

The terminal apparatuses 2 are terminals that are used by users. The users are users who create secondary content or users who perform an operation on secondary content, for example. The primary content and the secondary content will be described below in detail. The terminal apparatuses 2 may be personal computers, tablet computing devices, or smartphones, for example. Alternately, any other suitable terminal apparatus may be utilized. There is no limitation on the type of terminal apparatus 2.

The P2P networks 3 are preferably networks that configure a blockchain. The P2P networks 3 are preferably networks of apparatuses that manage distributed ledgers. It is preferable that two or more nodes constituting the information system A configure one blockchain. It is also preferable that four or more nodes constituting the information system A configure two or more blockchains. The nodes in this example may be considered as the servers 3.

The information processing apparatus 1 and each of the one or more terminal apparatuses 2 can communicate with each other by means of a network such as the Internet 4. The information processing apparatus 1 and each of the one or more P2P networks 3 can communicate with each other by means of a network such as the Internet 4.

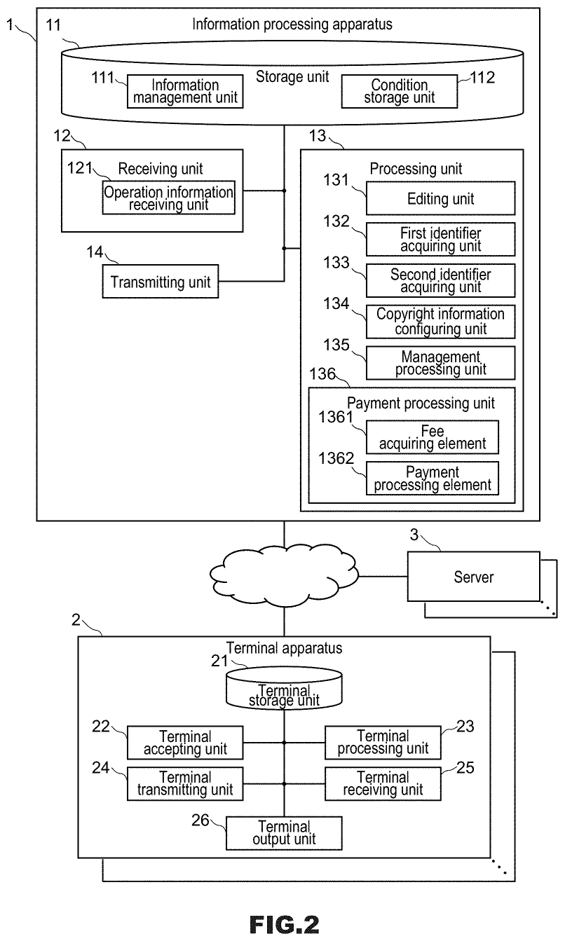

FIG. 2 is a block diagram of the information system A in this embodiment. The information processing apparatus 1 constituting the information system A includes a storage unit 11, a receiving unit 12, a processing unit 13, and a transmitting unit 14. The storage unit 11 includes an information management unit 111 and a conditional storage unit 112. The receiving unit 12 includes an operation information receiving unit 121. The processing unit 13 includes an editing unit 131, a first identifier acquiring unit 132, a second identifier acquiring unit 133, a copyright information configuring unit 134, a management processing unit 135, and a payment processing unit 136. The payment processing unit 136 includes a fee acquiring element 1361 and a payment processing element 1362.

The terminal apparatuses 2 each include a terminal storage unit 21, a terminal accepting unit 22, a terminal processing unit 23, a terminal transmitting unit 24, a terminal receiving unit 25, and a terminal output unit 26.

Various types of information are stored in the storage unit 11 constituting the information processing apparatus 1. Exemplary types of information are described below as hierarchical copyright information, editability conditions, primary content, and secondary content.

One or more pieces of hierarchical copyright information are stored in the information management unit 111. The hierarchical copyright information consists of the copyright information of the secondary content, as described below. The first copyright information associated with the primary content may be stored in the information management unit 111. The primary content may be a digital original creative work. The secondary content may be a digital derivative creative work. Preferably, the content in this example is a creative work. There is no limitation on whether or not the content is actually protected as a creative work under the laws of each country. It is assumed that, even if the content is not a creative work, the copyright information as defined in this specification can be conceived of in the same manner.

Alternately, the two or more servers 3 alone may manage the one or more pieces of hierarchical copyright information or the one or more pieces of first copyright information, using blockchain mechanisms. In this case, the information management unit 111 is not necessary.

The secondary content is preferably created using the one or more pieces of primary content. The content may consist of still images, moving images, sound, music, video with sound, text, three-dimensional assets, or a combination thereof, for example. There is no limitation on the type thereof. Still images and three-dimensional assets may optionally be avatars. An avatar is preferably an icon or figure representing a person, a character, or an animal. Alternately, an avatar may represent any other suitable object. The moving images may contain avatars. The avatars are preferably three-dimensional content, for example. Alternately, the avatars may be two-dimensional content. The primary content in this example may optionally contain content from which the primary content was created. Therefore, the secondary content is content of one order higher than the primary content. Therefore, the secondary content may be considered as (N+1)-order content, and the primary content may be considered as N-order content. N is a natural number of one or more.

The hierarchical copyright information contains second copyright information and one or more first identifiers. The second copyright information preferably consists of copyright information of the secondary content. The second copyright information preferably contains a second identifier.

The copyright information is information on the copyright of content. The copyright information may be considered as information on the ownership of content. The copyright information typically contains an identifier. The identifier is information for identifying copyright information. In addition, the identifier is information for identifying content corresponding to the copyright information. The identifier may contain a blockchain address and an ID, for example. In this example, it is assumed that the identifier of the primary content is referred to as a first identifier, and the identifier of the secondary content is referred to as a second identifier. There is no limitation on the structure of the copyright information and the identifiers.

The copyright information typically contains owner information. The copyright information preferably contains author information. The owner information is information on an owner of content. The owner is a person who has the author's property right of content. The owner information typically contains a user identifier for identifying an owner. The owner information preferably contains an owner's blockchain address or transmission destination information for transmitting information to the owner, for example. The transmission destination information is, for example, an e-mail address, a telephone number, or short message service (SMS) user ID for notification. The author information preferably consists of information on an author who originally created the content. The author information typically contains a user identifier for identifying an author. The author information contains transmission destination information for transmitting information to the author, for example.

The copyright information preferably contains transfer date information, fee information, application destination information, or application source information, for example, in addition to the owner information and the author information. The transfer date information preferably consists of information for specifying the transfer date of the author's property right (ownership) of content. The transfer date information is “Nov. 5, 2021”, for example. The fee information preferably consists of information for specifying a fee at the time of transfer of the author's property right. The transfer date information is “$1,000” or “100,000 yen”, for example. The application destination information preferably consists of information on an application destination when corresponding content is used. The application destination information contains an identifier of content created using the corresponding content, for example. The application source information preferably consists of information on an application source of corresponding content. The application source information contains an identifier of content that was used to create the corresponding content, for example. This identifier of content is a first identifier. The application destination information and the application source information contain a usage pattern, for example. The application source information may contain only a usage pattern associated with the first identifier, for example. The usage pattern preferably consists of information for specifying how the primary content is used to create secondary content. The usage pattern may consist of “use-as-is”, “change of attribute value”, or “processing”, for example. The “use-as-is” is information indicating that primary content was copied as is to create secondary content. The “change of attribute value” is information indicating that primary content whose attribute value was changed was used to create secondary content. The “processing” is information indicating that primary content that was changed also in terms of those other than attribute values was used to create secondary content. The attribute value in this example consists of an attribute value of content or a portion of the content. The attribute value may consist of color, size, background color, text font, or text color, for example. The attribute value of the primary content may optionally be an attribute value of secondary content for which the primary content is to be used. Therefore, an exemplary attribute value of the primary content is an article worn by an avatar, such as clothing, shoes, or ornaments. The article may optionally be “for women” or “for men” corresponding to the gender of the avatar, for example.

The copyright information contains right-of-use information, for example. The right-of-use information preferably consists of information on the right to use content identified with an identifier contained in the copyright information. The right-of-use information may contain range information for specifying the range of use of the content. The range information preferably consists of action range information for specifying the range of the act of using the content, or user range information for specifying the range of users who can use the content, for example. The action range information preferably consists of “use-as-is”, “change of attribute value”, or “processing”, for example. The user range information is “everyone”, “specific users only (one or more user identifiers)”, or “users corresponding to specific attribute value”.

The copyright information preferably contains transmission destination information or account information, for example. The transmission destination information preferably consists of information for notifying information to an owner or an author of the content corresponding to the copyright information, and is a blockchain address, an e-mail address, a telephone number, or any other suitable destination address. The account information preferably consists of information on an account or the like of an owner or an author of the content corresponding to the copyright information, and is a blockchain address, a bank account number, a credit card number, or any other suitable payment account information.

The copyright information is preferably a non-fungible token (NFT). The “non-fungible token” or “NFT” typically refers to the whole or part of digital data such as photographs, videos, music, digital art, content, digital content created by information processors, or creative works, the uniqueness of which is ensured through appropriate means such as the use of blockchain mechanisms. The information is a non-fungible token (NFT) also in the case in which multiple tokens are issued for a single piece of digital data, such as in the ERC 1155 protocol, for example. The information is a non-fungible token (NFT) also in the case in which multiple pieces of digital art can be represented on a single smart contract. For some situations, if a smart contract contains not only digital art but also metadata, the whole or part of the smart contract containing the metadata may be referred to as a non-fungible token (NFT). It is assumed that, if the concept of NFT is expanded due to technological advances or changes in social conventions, the expanded concept is also included in the inventive content of this specification.

The copyright information is preferably information for specifying that the corresponding content is original and is not copied information. The copyright information is first copyright information or second copyright information, for example. The first copyright information is copyright information corresponding to the primary content. The second copyright information is copyright information corresponding to the secondary content. The primary content may alternately be content created using other content.

The copyright information such as the first copyright information, the second copyright information, and the hierarchical copyright information is preferably managed in association with content in a decentralized manner using blockchain mechanisms in the one or more P2P networks 3. The second copyright information can be said to be an example of the hierarchical copyright information.

One or more editability conditions are stored in the condition storage unit 112. Each editability condition is associated with the primary content. The editability condition may be associated with content such as the secondary content. Alternately, content may exist that is not associated with editability conditions.

The editability condition is a condition regarding the use of primary content in the case of creating secondary content. The editability condition may be one condition in a condition group including two or more conditions “use-as-is only”, “up to change of attribute value”, and “free”, for example. The editability condition may be “not available”, for example. The editability condition “use-as-is only” means that the primary content is only allowed to be used as is. The editability condition “up to change of attribute value” means that the primary content is allowed to be used as is and attribute values (color, size, etc.) of the primary content are allowed to be changed. The editability condition “free” means that the primary content is allowed to be freely changed and used to create secondary content. The editability condition “not available” means that the primary content is not available.

The editability condition may be contained in the copyright information, for example. The copyright information containing the editability conditions may be stored in each of the two or more servers 3. In this case, the condition storage unit 112 is not necessary.

The receiving unit 12 receives various types of information and instructions from the terminal apparatuses 2. The various types of information and instructions are operation information as described below, one or more first identifiers, and fee information, for example. The one or more first identifiers are identifiers of the primary content that are used to create secondary content. The fee information is information for specifying a fee for the sale of the content. Alternately, the fee information is information for specifying a fee designated by a creator of the content, for example.

The operation information receiving unit 121 receives operation information from the terminal apparatuses 2. The operation information preferably consists of information on an operation regarding the secondary content. The operation information is, for example, a sales instruction or an editing instruction. The operation information receiving unit 121 preferably receives operation information associated with a user identifier. The user identifier is information for identifying a user of the terminal apparatus 2. The user identifier preferably consists of a user ID, an e-mail address, a telephone number, or the like, for example. The user ID may be an ID of the terminal apparatus 2.

The sales instruction is an instruction to sell secondary content owned by one user to another user. The sales instruction preferably contains an identifier of content that is to be sold, and a user identifier for specifying a user to which content is to be sold, for example. The sales instruction is “sell (second identifier, user identifier)”, for example.

The editing instruction is various types of instructions to create the secondary content. The editing instruction preferably consists of an acquisition instruction, an attribute value change instruction, a change instruction, or a completion instruction, for example.

The acquisition instruction is an instruction to acquire one or more pieces of primary content when creating secondary content. The acquisition instruction is “acquire (first identifier)” or “acquire (first identifier A, first identifier B)”, for example. This acquisition instruction is an instruction to acquire the primary content identified with the first identifier from the servers 3 or the storage unit 11. The instruction that is acquired from the servers 3 may be an instruction that is acquired from the P2P networks 3.

The attribute value change instruction is an instruction to change one or more attribute values of already acquired primary content. The attribute value change instruction may consists of “change of attribute value (first identifier, color=red, size=0.8×)”, for example. This attribute value change instruction is an instruction to change the color of the already acquired primary content identified with the first identifier to red and to increase the size thereof by 0.8 times. The change instruction is an instruction to change already acquired primary content.

The change instruction is various instructions to change the shape of the primary content, to add another figure to the primary content, or to change a portion of the primary content that is a piece of music, for example. The change instruction may be various instructions to change the secondary content, for example. The change instruction is an instruction to edit an avatar that is the secondary content, or an instruction to edit clothing that is the primary content worn by the avatar, for example. The primary content that is used to create the secondary content may be part of the content.

Furthermore, if two pieces of primary content that are avatars wearing different clothing have been acquired with an acquisition instruction, the change instruction is an instruction to swap the clothing worn by these two avatars, for example. If two pieces of primary content that are one avatar wearing a wristwatch and the other not wearing a wristwatch have been acquired with a sales instruction, the change instruction is an instruction to remove the wristwatch from the one avatar and put it on the other avatar, for example.

The completion instruction is an instruction to complete the creation of secondary content. The completion instruction is “complete (second identifier, fee information)”, for example.

The processing unit 13 preferably performs various types of processing. The various types of processing are preferably processing that is performed by the editing unit 131, the first identifier acquiring unit 132, the second identifier acquiring unit 133, the copyright information configuring unit 134, the management processing unit 135, or the payment processing unit 136, for example.

The editing unit 131 preferably creates secondary content, in response to an editing instruction to create the secondary content using one or more pieces of primary content. The editing unit 131 creates secondary content in response to an editing instruction received by the operation information receiving unit 121.

In response to the acquisition instruction received by the operation information receiving unit 121, the editing unit 131 acquires primary content identified with the first identifiers contained in the acquisition instruction, from the servers 3 or the storage unit 11. The editing unit 131 acquires primary content stored in any one of the two or more servers 3, using the first identifiers contained in the acquisition instruction as a key, for example. The acquiring primary content from the servers 3 may be acquiring primary content from the P2P networks 3. The editing unit 131 preferably acquires first copyright information of the primary content as well in association with the primary content. The editing unit 131 acquires first copyright information from a blockchain, using the first identifiers, for example. The first copyright information may alternately be an NFT.

The editing unit 131 changes one or more attribute values of already acquired primary content, in response to the attribute value change instruction received by the operation information receiving unit 121. This processing is a known authoring technology.

The editing unit 131 changes already acquired primary content in response to the change instruction received by the operation information receiving unit 121. This processing is known authoring technology. The editing unit 131 acquires editability conditions respectively associated with the one or more pieces of primary content, and creates the secondary content according to the editing instruction within a range allowed by the editability conditions respectively corresponding to the one or more pieces of primary content.

If the editability condition corresponding to the primary content is “use-as-is only”, the editing unit 131 does not change the primary content in response to the attribute value change instruction or the change instruction received by the operation information receiving unit 121. If the editability condition corresponding to the primary content is “use-as-is only”, the editing unit 131 acquires primary content from the servers 3 or the storage unit 11, in response to the acquisition instruction received by the operation information receiving unit 121.

If the editability condition corresponding to the primary content is “up to change of attribute value”, the editing unit 131 does not change the primary content in response to the change instruction received by the operation information receiving unit 121. If the editability condition corresponding to the primary content is “up to change of attribute value”, the editing unit 131 acquires primary content from the servers 3 or the storage unit 11, in response to the acquisition instruction received by the operation information receiving unit 121. In this case, the editing unit 131 changes an attribute value of the primary content in response to the attribute value change instruction received by the operation information receiving unit 121.

If the editability condition corresponding to the primary content is “free”, the editing unit 131 creates the secondary content in response to an editing instruction received by the operation information receiving unit 121.

If the editability condition corresponding to the primary content is “not available”, the editing unit 131 does not perform processing in response to the editing instruction received by the operation information receiving unit 121.

The first identifier acquiring unit 132 acquires one or more first identifiers for respectively identifying one or more pieces of primary content that were used to create secondary content. The first identifier acquiring unit 132 preferably acquires first copyright information containing the first identifiers. The first identifier acquiring unit 132 acquires first copyright information from a blockchain, using the first identifiers, for example.

The first identifier acquiring unit 132 acquires the first identifiers or the first copyright information acquired by the editing unit 131, for example. The first identifier acquiring unit 132 acquires the one or more first identifiers received by the receiving unit 12, for example. The first identifier acquiring unit 132 acquires the first identifiers of the respective one or more pieces of primary content acquired by the editing unit 131, the first identifiers being contained in the acquisition instruction received by the operation information receiving unit 121, for example. The first identifier acquiring unit 132 preferably acquires the one or more pieces of first copyright information of the primary content acquired by the editing unit 131, the first copyright information being contained in the acquisition instruction received by the operation information receiving unit 121. There is no limitation on the method or procedure in which the first identifier acquiring unit 132 acquires the first identifier or the first copyright information.

The first identifier acquiring unit 132 may acquire link information to the first copyright information of the primary content. The first identifier acquiring unit 132 may acquire link information to the first identifiers of the primary content. The first identifier acquiring unit 132 acquiring the first identifiers may be acquiring link information for the first identifier acquiring unit 132 to acquire the first identifiers. The link information is a URI or a URL, for example, but there is no limitation on the type thereof.

The second identifier acquiring unit 133 acquires a second identifier for identifying secondary content created using the one or more pieces of primary content.

The second identifier acquiring unit 133 acquires a second identifier unique to the secondary content created by the editing unit 131, for example. The second identifier acquiring unit 133 preferably creates a second identifier unique to the secondary content, but may read a second identifier stored in a buffer (not shown). The second identifier acquiring unit 133 creates a second identifier using an identifier unique to the information processing apparatus 1 and the current date and time, for example. The second identifier acquiring unit 133 acquires an identifier unique to the information processing apparatus 1 from the storage unit 11, acquires the current date and time from a clock (not shown), and substitutes the unique identifier and the current date and time for a hash function, thereby acquiring a second identifier that is a hash value, for example. The second identifier acquiring unit 133 acquires a user identifier for identifying a user who created the secondary content, for example. The second identifier acquiring unit 133 acquires a user identifier that is paired with the user identifier received by the receiving unit 12 or the operation information received by the operation information receiving unit 121, for example. The second identifier acquiring unit 133 acquires a creation date, which is a date obtained from a clock (not shown) and a date when the creation of the secondary content was completed, from the clock, for example. The second identifier acquiring unit 133 acquires the fee information received by the receiving unit 12, for example. The second identifier acquiring unit 133 acquires a blockchain address and a unique ID, and acquires a second identifier containing the blockchain address and the ID, for example.

The copyright information configuring unit 134 configures hierarchical copyright information containing the second identifier acquired by the second identifier acquiring unit 133 and the one or more first identifiers acquired by the first identifier acquiring unit 132. The hierarchical copyright information may acquire link information to the second identifier acquired by the second identifier acquiring unit 133 or link information to the one or more first identifiers. The acquiring such link information may be considered as acquiring information on a link destination. The copyright information configuring unit 134 may encrypt the hierarchical copyright information containing the second identifier and the like using a hash function or other suitable means. The encrypted hierarchical copyright information is also hierarchical copyright information.

The copyright information configuring unit 134 preferably configures hierarchical copyright information containing one or more of author information containing a user identifier of a user who created the secondary content, owner information containing the user identifier, creation date information, fee information, and a usage pattern that is paired with the first identifier. The author information is information on a user who has the author's moral rights. The owner information is information for specifying an owner of an author's property right. The creation date information is information for specifying a date when the content was created. The fee information is information for specifying the selling price of the content. The usage pattern is one of “use-as-is”, “change of attribute value”, and “processing”, for example. The fee information is contained in the received completion instruction, for example.

The copyright information configuring unit 134 may configure copyright information of primary content that does not use other content. In this case, the copyright information contains a first identifier, author information, owner information, creation date information, and fee information, for example.

The management processing unit 135 performs management processing for managing the hierarchical copyright information configured by the copyright information configuring unit 134, in association with the secondary content. The management processing is typically processing for accumulating the hierarchical copyright information and the secondary content in association with each other in one or more apparatuses. The one or more apparatuses are the information processing apparatus 1 and the two or more servers 3, for example. The two or more servers 3 typically constitute P2P networks. Alternately, the two or more servers 3 are blockchains, for example. Therefore, the management processing unit 135 preferably registers the hierarchical copyright information in a blockchain in association with the secondary content.

After the terminal apparatuses 2 or information processing apparatus 1 that is a terminal (as described below) sends an encrypted message containing hierarchical copyright information to a blockchain, the management processing unit 135 may acquire information corresponding to the message (e.g., hierarchical copyright information, or hierarchical copyright information and secondary content) from the blockchain, and accumulate it in the storage unit 11. If the terminal apparatuses 2 or a information processing apparatus 1 (described below) that is a terminal sends an encrypted message containing hierarchical copyright information to a blockchain, information in which information on owner/time/content, etc. of secondary content is written is accumulated on a distributed ledger. In this case, the owner's ID on the blockchain matches the sender's blockchain ID.

The management processing unit 135 may perform management processing for managing first copyright information of the primary content configured by the copyright information configuring unit 134, in association with the primary content.

The management processing unit 135 preferably performs management processing for managing the hierarchical copyright information configured by the copyright information configuring unit 134, in association with the secondary content, using blockchain mechanisms, for example. The management processing unit 135 may transmit the hierarchical copyright information configured by the copyright information configuring unit 134 and the secondary content created by the editing unit 131 to the two or more servers 3, for example. The management processing unit 135 transmits the hierarchical copyright information and the secondary content, for example, via a wallet on the client side (e.g., the terminal apparatuses 2) as an encrypted message to the P2P networks 3, for example. In this case, the hierarchical copyright information and the secondary content are accumulated in association with each other in the two or more servers 3. The management processing unit 135 may manage the hierarchical copyright information and the secondary content in association with each other using blockchain mechanisms such as the ERC721 protocol, for example.

The copyright information is preferably managed by being written to metadata in the blockchain or metadata indicated by a URL in the blockchain, through the management processing by the management processing unit 135, for example.

The management processing unit 135 performs application destination information adding processing or application source information adding processing, for example. The application destination information adding processing is processing for registering application destination information in the copyright information of lower-level content, when the lower-level content (e.g., primary content) was used to create upper-level content (e.g., secondary content). The application destination information is information indicating that the content was used. The application destination information contains an identifier of the upper-level content that used the lower-level content. The application destination information contains the date of use and the usage pattern, for example. The application source information adding processing is processing for registering application source information in the copyright information of upper-level content, when lower-level content (e.g., primary content) was used to create the upper-level content (e.g., secondary content). The application source information is information on the lower-level content (primary content). The application source information contains an identifier of the lower-level content that was used by the upper-level content. The application source information contains the date of use and the owner, for example.

The payment processing unit 136 performs payment processing for paying a fee to one or more subjects among an author and an owner corresponding to the one or more first identifiers of the respective one or more pieces of primary content corresponding to the editing instruction received by the operation information receiving unit 121, the first identifiers being acquired by the first identifier acquiring unit 132. The payment processing unit 136 preferably performs payment processing such that the fees for the one or more pieces of primary content are different according to the editing instruction. The editing instruction is one of “use-as-is only”, “up to change of attribute value”, and “free”, for example. The payment processing unit 136 preferably calculates and performs payment processing such that the fees are ranked higher in the order of “use-as-is only”<“up to change of attribute value”<“free”.

The payment processing unit 136 acquires the second identifier corresponding to the sales instruction received by the operation information receiving unit 121, acquires one or more first identifiers that are paired with the second identifier, from the hierarchical copyright information corresponding to the second identifier, and performs payment processing for paying a fee to one or more subjects among an author and an owner corresponding to the one or more first identifiers and one or more subjects among an author and an owner corresponding to the second identifier.

The payment processing may be any processing related to the payment of a fee. The payment processing is processing for notifying a subject who is an author or an owner of fee information for specifying a fee that is to be paid to the subject, for example. The payment processing is processing for calculating fees that are to be respectively paid to two or more subjects and outputting fee information for specifying the fees, for example. The output in this example may be notification to the two or more subjects, accumulation in a storage medium, or any other suitable output. The payment processing preferably consists of processing for calculating fees that are to be respectively paid to two or more subjects and transferring the amounts of money corresponding to the fees to the bank accounts or the like respectively corresponding to the subjects, for example. The payment processing for transferring money to a bank account or other suitable location is a technique well known to those skilled in the art. Therefore, a detailed description thereof has been omitted.

The fee acquiring element 1361 acquires fees to the respective two or more subjects, using one or more of hierarchy information indicating whether the two or more subjects are subjects of the primary content or subjects of the secondary content, and degrees of contribution by the subjects in the secondary content. The degrees of contribution by the subjects are the degrees of contribution in primary content or different degrees of contribution by an author and an owner, for example. The degrees of contribution are associated with the first identifiers and contained in the hierarchical copyright information. The “degrees of contribution” may be any information that can be used to distribute the fees to the subjects, and may reflect the actual contribution of each subject to the creation of the secondary content, but there is no limitation to this.

If the operation information received by the operation information receiving unit 121 is a sales instruction of secondary content (e.g., “sell (second identifier)”, the fee acquiring element 1361 acquires hierarchical copyright information of secondary content identified with the second identifier. Next, the fee acquiring element 1361 acquires fee information (M yen) contained in the hierarchical copyright information. Next, the fee acquiring element 1361 acquires the number of first identifiers (X) contained in the hierarchical copyright information. Next, the payment processing unit 136 adds the number of first identifiers (X) and the number of second identifiers (1), thereby calculating the number of authors (X+1) who receive payment. Next, the fee acquiring element 1361 calculates the amount of money “P yen=M yen/(X+1)” that is to be paid to each author.

Optionally for example, the fee acquiring element 1361 sets the fee to the author of the secondary content to a fix ratio (e.g., 4/5) of the fee information (M yen) contained in the hierarchical copyright information, thereby calculating the fee (e.g., (4M/5) yen), and equally divides the remainder, thereby calculating the fees to the authors of the primary content that was used to create secondary content (e.g., (M/10) yen). Therefore, there is no limitation on the method in which the fee acquiring element 1361 calculates a fee.

The payment processing element 1362 performs payment processing using the fees to the respective two or more authors acquired by the fee acquiring element 1361.

The payment processing element 1362 transmits fee information indicating that P yen will be paid to each author for the sale of the secondary content, for example. It is assumed that a transmission destination identifier indicating a transmission destination of information to each author is stored in pair with a user identifier in the storage unit 11. The payment processing element 1362 performs processing for, in order to pay P yen to each author, transferring the amount of money corresponding to the fee to a bank account or other suitable account or location corresponding to the author, for example. It is assumed that account information such as the account number of each author is stored in pair with a user identifier in the storage unit 11.

The transmitting unit 14 transmits various types of information. The transmitting unit 14 transmits various types of information to the terminal apparatuses 2 or the servers 3. The various types of information are the copyright information of created content, information indicating that secondary content that is paired with the second copyright information is managed by two or more servers 3, information indicating that secondary content that is paired with the second copyright information is accumulated in the storage unit 11, and various error messages, for example.

Various types of information are stored in the terminal storage unit 21 constituting the terminal apparatuses 2. The various types of information are user identifiers, for example.

The terminal accepting unit 22 accepts various types of information, instructions, and other information. The various types of information, instructions, and the like are operation information, one or more first identifiers, and fee information, for example.

In this example, the accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory, or any other suitable information storage means.

The various types of information, instructions, and other information may be input by any device such as a touch panel, a keyboard, a mouse, or a menu screen, or any other suitable input means.

The terminal processing unit 23 performs various types of processing. The various types of processing are preferably processing for changing the accepted information, instructions, and the like into information, instructions, and the like with a structure for transmission, for example. The various types of processing are processing for changing the received information into information with a structure for output, for example.

The terminal transmitting unit 24 transmits various types of information, instructions, and the like to the information processing apparatus 1. The various types of information, instructions, and the like are operation information, one or more first identifiers, and fee information, for example.

The terminal receiving unit 25 receives various types of information from the information processing apparatus 1. The various types of information are copyright information, fee information, information indicating that the created secondary content is managed by two or more servers 3 (using blockchain mechanisms), information indicating that the created secondary content is accumulated in the information processing apparatus 1, information indicating that the secondary content was sold, and information indicating that the primary content created by a user who is an author was used, for example.

The terminal output unit 26 outputs various types of information. The various types of information are copyright information, fee information, information indicating that secondary content is managed by two or more servers 3, information indicating that the secondary content was sold, and information indicating that the primary content created by a user who is an author was used, for example.

In this example, the output is a concept that encompasses display on a display screen, projection using a projector, printing by a printer, output of a sound, transmission to an external apparatus, accumulation in a storage medium, delivery of a processing result to another processing apparatus or another program, or any other suitable output device or means.

The storage unit 11, the information management unit 111, the condition storage unit 112, and the terminal storage unit 21 are preferably non-volatile storage media, but may alternately be realized by volatile storage media.

There is no limitation on the procedure in which information is stored in the storage unit 11 and the like. For example, information may be stored in the storage unit 11 and the like via a storage medium, information transmitted via a communication line or the like may be stored in the storage unit 11 and the like, or information input via an input device may be stored in the storage unit 11 and the like.

The receiving unit 12, the operation information receiving unit 121, and the terminal receiving unit 25 are typically realized by wireless or wired communication elements.

The processing unit 13, the editing unit 131, the first identifier acquiring unit 132, the second identifier acquiring unit 133, the copyright information configuring unit 134, the management processing unit 135, the payment processing unit 136, the fee acquiring element 1361, the payment processing element 1362, and the terminal processing unit 23 may be realized typically by processors, memories, or the like. Typically, the processing procedure of the processing unit 13 and the like is realized by software, and the software is stored in a storage medium such as a ROM. The processing procedure may be realized by hardware (a dedicated circuit). The processors may be central processing units (CPUs), multiple processing units (MPUs), or graphics processing units (GPUs), for example. There is no limitation on the type thereof.

The transmitting unit 14, and the terminal transmitting unit 24 are typically realized by wireless or wired communication elements.

The terminal accepting unit 22 may consist of a device driver for an input device such as a touch panel or a keyboard, control software for a menu screen, or any other suitable device or means.

The terminal output unit 26 may be considered to include or to not include an output device such as a display screen or a speaker. The terminal output unit 26 may consist of driver software for an output device, a combination of driver software for an output device and the output device, or any other suitable device or means.

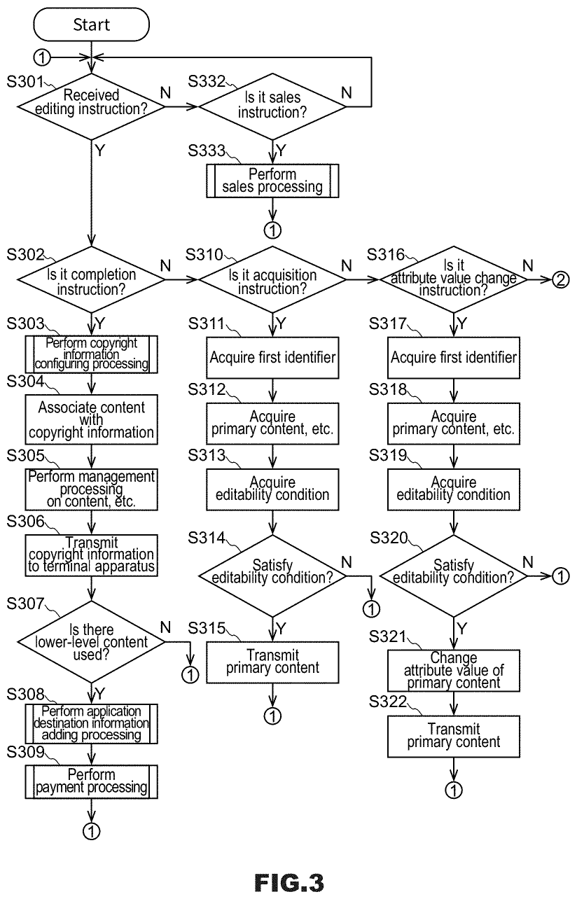

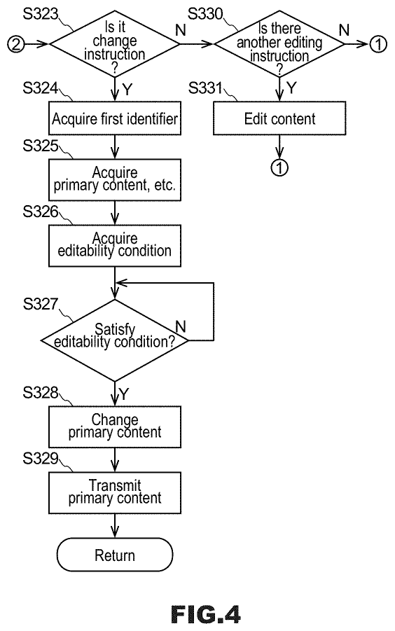

Next, an operation example of the information system A will be described. First, an operation example of the information processing apparatus 1 will be described with reference to the flowcharts in FIGS. 3 and 4.

(Step S301) The operation information receiving unit 121 determines whether or not it has received an editing instruction from a terminal apparatus 2. If it has received an editing instruction, the procedure advances to step S302. Alternately, the procedure advances to step S332.

(Step S302) The processing unit 13 determines whether or not the editing instruction received in step S301 is a completion instruction. If it is a completion instruction, the procedure advances to step S303. Alternately, the procedure advances to step S310.

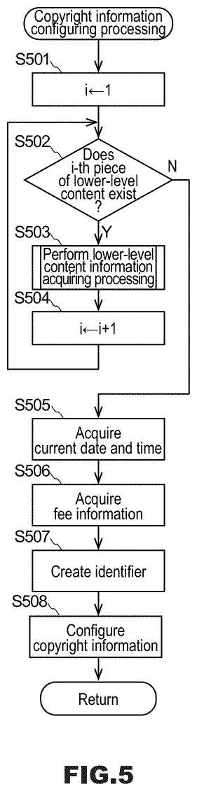

(Step S303) The processing unit 13 performs processing for configuring copyright information of created content. Below, an example of this copyright information configuring processing will be described with reference to the flowchart in FIG. 5. The created content is content corresponding to the completion instruction.

(Step S304) The management processing unit 135 performs processing for associating the created content with the copyright information acquired in step S303.

(Step S305) The management processing unit 135 performs management processing for registering the content associated in step S304 and the copyright information. This management processing is processing for registering the content and the copyright information in the servers 3 of two or more distributed ledgers constituting a blockchain, for example.

(Step S306) The transmitting unit 14 performs processing for transmitting the copyright information acquired in step S303 to the terminal apparatus 2 that transmitted the completion instruction. In this example, the transmitting unit 14 may transmit information indicating that the content and the copyright information were registered in the server group constituting the blockchain, to the terminal apparatus 2.

(Step S307) The processing unit 13 determines whether or not there is lower-level content (e.g., primary content) that was used to create content (e.g., secondary content) corresponding to the received completion instruction. If there is lower-level content, the procedure advances to step S308. Alternately, the procedure returns to step S301. The processing unit 13 refers to the copyright information acquired in step S303, and determines whether or not there is an identifier of the lower-level content in the copyright information, for example.

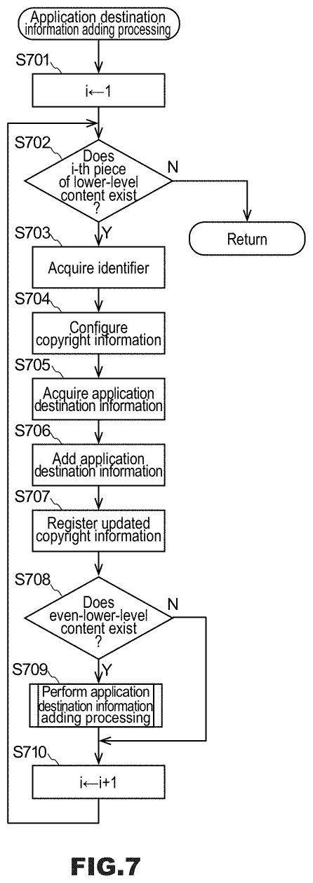

(Step S308) The management processing unit 135 performs application destination information adding processing. Below, an example of this application destination information adding processing will be described with reference to the flowchart in FIG. 7.

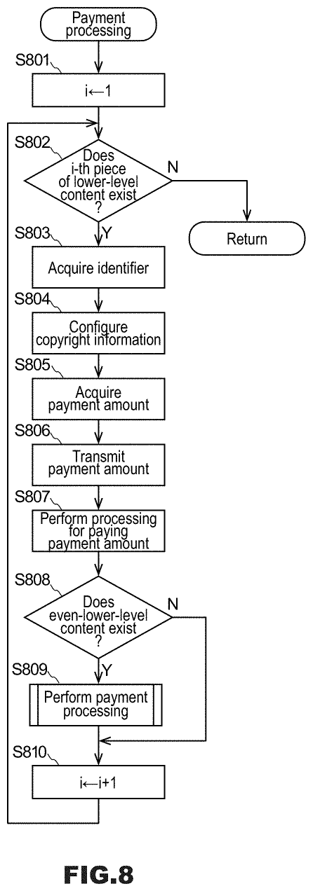

(Step S309) The payment processing unit 136 performs payment processing to an author or an owner of the lower-level content. Below, an example of this payment processing will be described with reference to the flowchart in FIG. 8.

(Step S310) The processing unit 13 determines whether or not the editing instruction received in step S301 is an acquisition instruction. If it is an acquisition instruction, the procedure advances to step S311. Alternately, the procedure advances to step S316.

(Step S311) The first identifier acquiring unit 132 acquires a first identifier contained in the acquisition instruction. Therefore, the first identifier acquiring unit 132 acquires an identifier for identifying content that is to be acquired.

(Step S312) The editing unit 131 acquires primary content and the like identified with the first identifier acquired in step S311. The primary content and the like are the primary content and first copyright information, for example. The editing unit 131 acquires first copyright information that is an NFT from a wallet of the blockchain, using the first identifier acquired in step S311, for example.

(Step S313) The editing unit 131 acquires an editability condition that is paired with the first identifier acquired in step S311. The editability condition may be stored in the condition storage unit 112 or contained in the first copyright information.

(Step S314) The editing unit 131 determines whether or not the received “acquisition instruction” satisfies the editability condition acquired in step S313. Therefore, the editing unit 131 preferably determines whether or not it is possible to use the primary content as is, using the editability condition. If the editability condition is satisfied, the procedure advances to step S315. Alternately the procedure returns to step S301. If the editability condition is not satisfied, the transmitting unit 14 may transmit an error message indicating that “the primary content is not available”, to the terminal apparatus 2.

(Step S315) The editing unit 131 transmits the primary content acquired in step S312 to the terminal apparatus 2. The procedure returns to step S301. This primary content may be output to the terminal apparatus 2 and subjected to editing.

(Step S316) The processing unit 13 determines whether or not the editing instruction received in step S301 is an attribute value change instruction. If it is an attribute value change instruction, the procedure advances to step S303. Alternately, the procedure advances to step S310.

(Step S317) The editing unit 131 acquires a first identifier contained in the received attribute value change instruction.

(Step S318) The editing unit 131 acquires primary content and the like identified with the first identifier acquired in step S317. Typically, the primary content and the like are already held in the information processing apparatus 1.

(Step S319) The editing unit 131 acquires an editability condition that is paired with the first identifier acquired in step S317.

(Step S320) The editing unit 131 determines whether or not the received “attribute value change instruction” satisfies the editability condition acquired in step S319. Therefore, the editing unit 131 determines whether or not it is possible to change an attribute value of the primary content, using the editability condition. If the editability condition is satisfied, the procedure advances to step S321. Alternately, the procedure returns to step S301. If the editability condition is not satisfied, the transmitting unit 14 may transmit an error message indicating that “an attribute value of the primary content cannot be changed”, to the terminal apparatus 2.

(Step S321) The editing unit 131 acquires primary content that is paired with the first identifier acquired in step S317. Then, the editing unit 131 changes an attribute value of the primary content in response to the received attribute value change instruction. Typically, the primary content is already held in the information processing apparatus 1.

(Step S322) The editing unit 131 transmits the primary content whose attribute value was changed in step S321, to the terminal apparatus 2. The procedure returns to step S301.

(Step S323) The processing unit 13 determines whether or not the editing instruction received in step S301 is a change instruction. If it is a change instruction, the procedure advances to step S303. Alternately, the procedure advances to step S310.

(Step S324) The editing unit 131 acquires a first identifier contained in the received change instruction.

(Step S325) The editing unit 131 acquires primary content and the like identified with the first identifier acquired in step S324.

(Step S326) The editing unit 131 acquires an editability condition that is paired with the first identifier acquired in step S324.

(Step S327) The editing unit 131 determines whether or not the received “change instruction” satisfies the editability condition acquired in step S326. Therefore, the editing unit 131 determines whether or not it is possible to change the primary content based on the change instruction, using the editability condition. If the editability condition is satisfied, the procedure advances to step S328. Alternately, the procedure returns to step S301. If the editability condition is not satisfied, the transmitting unit 14 may transmit an error message indicating that “the primary content cannot be changed”, to the terminal apparatus 2.

(Step S328) The editing unit 131 acquires primary content that is paired with the first identifier acquired in step S324. Then, the editing unit 131 changes the primary content in response to the received change instruction. Typically, the primary content is already held in the information processing apparatus 1.

(Step S329) The editing unit 131 transmits the primary content changed in step S328, to the terminal apparatus 2. The procedure returns to step S301.

(Step S330) The processing unit 13 determines whether or not the editing instruction received in step S301 is another editing instruction of the content. If it is another editing instruction, the procedure advances to step S331. Alternately, the procedure returns to step S301. The other editing instruction is an instruction for editing other than the “completion instruction”, the “acquisition instruction”, the “attribute value change instruction”, and the “change instruction”.

(Step S331) The editing unit 131 edits the content in response to the received other editing instruction. The procedure returns to step S301.

(Step S332) The operation information receiving unit 121 determines whether or not it has received a sales instruction from the terminal apparatus 2. If it has received a sales instruction, the procedure advances to step S333. Alternately, the procedure returns to step S301.

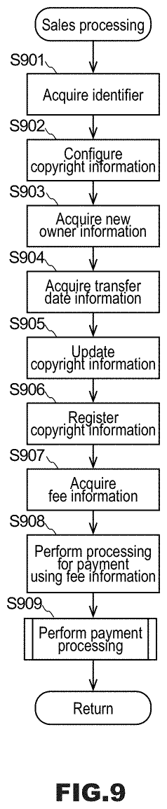

(Step S333) The processing unit 13 performs sales processing. Below, an example of this sales processing will be described with reference to the flowchart in FIG. 9.

In the flowcharts in FIGS. 3 and 4, the processing ends at power off or at an interruption of termination processing.

Next, an example of the copyright information configuring processing in step S303 will be described with reference to the flowchart in FIG. 5.

(Step S501) The processing unit 13 substitutes 1 for a counter i.

(Step S502) The processing unit 13 determines whether or not there is an i^{-th} piece of lower-level content that was used to create content (which may be referred to as “focused content”) corresponding to the completion instruction. If there is an i^{-th} piece of lower-level content, the procedure advances to step S503. Alternately, the procedure advances to step S505.

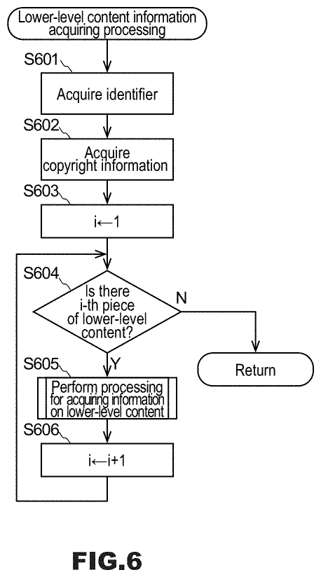

(Step S503) The processing unit 13 performs lower-level content information acquiring processing. Below, an example of this lower-level content information acquiring processing will be described with reference to the flowchart in FIG. 6. The lower-level content information acquiring processing is processing for acquiring copyright information of the content that was used to create the focused content.

(Step S504) The processing unit 13 increments the counter i by 1. The procedure returns to step S502.

(Step S505) The second identifier acquiring unit 133 acquires the current date and time from a clock (not shown).

(Step S506) The second identifier acquiring unit 133 acquires fee information. The fee information is information for specifying a fee for the focused content. The fee information is contained in the completion instruction, for example. The fee information may be obtained in any suitable manner.

(Step S507) The second identifier acquiring unit 133 creates a unique identifier of the focused content. This identifier is a second identifier, for example.

(Step S508) The copyright information configuring unit 134 configures copyright information containing the lower-level content information acquired in step S503, the date and time acquired in step S505, the fee information acquired in step S506, and the identifier acquired in step S507. The procedure returns to the upper-level processing. In this example, the copyright information configuring unit 134 preferably configures copyright information containing a usage pattern as well in association with the lower-level content.

Next, an example of the lower-level content information acquiring processing in step S503 will be described with reference to the flowchart in FIG. 6.

(Step S601) The first identifier acquiring unit 132 acquires an identifier of the lower-level content. This identifier of the lower-level content is an identifier of the lower-level content that was used to create the secondary content, and is held in the information processing apparatus 1 or contained in the copyright information of the lower-level content, for example.

(Step S602) The copyright information configuring unit 134 acquires copyright information corresponding to the identifier acquired in step S601. The copyright information configuring unit 134 may acquire copyright information already held in the information processing apparatus 1. Alternately, copyright information configuring unit 134 may acquire copyright information from any server 3. The copyright information configuring unit 134 may also acquire a usage pattern of the lower-level content in the upper-level content. The usage pattern is “use-as-is”, “change of attribute value”, or “processing”, for example.

(Step S603) The processing unit 13 substitutes 1 for a counter i.

(Step S604) The processing unit 13 determines whether or not there is an i^{-th} piece of even-lower-level content, which is lower than the focused lower-level content. If there is an i^{-th} piece of even-lower-level content, the procedure advances to step S605. Alternately, the procedure returns to the upper-level processing.

(Step S605) The processing unit 13 performs processing for acquiring information on the i^{-th} piece of even-lower-level content. This processing is lower-level content information acquiring processing. Therefore, this recursive processing enables the acquisition of copyright information at three or more levels.

(Step S606) The processing unit 13 increments the counter i by 1. The procedure returns to step S604.

Next, an example of the application destination information adding processing in step S308 will be described with reference to the flowchart in FIG. 7.

(Step S701) The management processing unit 135 substitutes 1 for a counter i.

(Step S702) The management processing unit 135 determines whether or not there is an i^{-th} piece of lower-level content that was used to create the focused content. If there is an i^{-th} piece of lower-level content, the procedure advances to step S703. Alternately, the procedure returns to the upper-level processing. The focused content is content corresponding to the completion instruction in step S302, for example.

(Step S703) The management processing unit 135 acquires an identifier of the i^{-th} piece of lower-level content. The identifier of the i^{-th} piece of lower-level content is an identifier corresponding to the acquisition instruction received in step S310, and is held in the information processing apparatus 1.

(Step S704) The management processing unit 135 acquires copyright information corresponding to the identifier of the i^{-th} piece of lower-level content. The management processing unit 135 may acquire copyright information held in the information processing apparatus 1. Alternately, management processing unit 135 may acquire copyright information held in any server 3, using the identifier of the i^{-th} piece of lower-level content. The copyright information is preferably held in all servers 3 of the two or more servers 3.

(Step S705) The management processing unit 135 acquires a second identifier of the secondary content corresponding to the completion instruction. The management processing unit 135 configures application destination information of the i^{-th} piece of lower-level content, the application destination information containing the second identifier. The management processing unit 135 preferably acquires date information from a clock (not shown), and configures application destination information containing the date information.

(Step S706) The management processing unit 135 adds the application destination information configured in step S705 to the copyright information acquired in step S704, thereby configuring new copyright information.

(Step S707) The management processing unit 135 performs processing for registering the new copyright information configured in step S706. The registering processing in this example is accumulating processing in the two or more servers 3, for example, but may be accumulating processing in the storage unit 11. The accumulating processing in the two or more servers 3 is preferably registering processing using blockchain mechanisms.

(Step S708) The management processing unit 135 determines whether or not there is even-lower-level content that was used to create the i^{-th} piece of lower-level content, using the copyright information acquired in step S704. If there is even-lower-level content, the procedure advances to step S709. Alternately, the procedure advances to step S710.

(Step S709) The management processing unit 135 performs application destination information adding processing while taking the i^{-th} piece of lower-level content as the focused content. Accordingly, the application destination information adding processing is recursively performed.

(Step S710) The management processing unit 135 increments the counter i by 1. The procedure returns to step S702.

Next, an example of the payment processing in step S309 will be described with reference to the flowchart in FIG. 8.

(Step S801) The payment processing unit 136 substitutes 1 for a counter i.

(Step S802) The payment processing unit 136 determines whether or not there is an i^{-th} piece of lower-level content that was used to create the focused content. If there is an i^{-th} piece of lower-level content, the procedure advances to step S803. Alternately, the procedure returns to the upper-level processing. The focused content is content corresponding to the completion instruction in step S302, for example.

The payment processing unit 136 acquires copyright information corresponding to the identifier (e.g., a second identifier) of the focused content, and determines whether or not there is an identifier (e.g., a first identifier) of the i^{-th} piece of lower-level in the copyright information.

(Step S803) The payment processing unit 136 acquires an identifier of the i^{-th} piece of lower-level content. The payment processing unit 136 acquires an identifier of the i^{-th} piece of lower-level content from the copyright information of the focused content, for example.

(Step S804) The payment processing unit 136 acquires copyright information corresponding to the identifier of the i^{-th} piece of lower-level content.

(Step S805) The payment processing unit 136 acquires a fee for use of the i^{-th} piece of lower-level content in the focused content, the fee being the payment amount that is to be paid to an author or an owner of the i^{-th} piece of lower-level content.

(Step S806) The payment processing unit 136 transmits information on the payment amount acquired in step S805, to the author or the owner of the i^{-th} piece of lower-level content. The transmission destination information of the author or the owner of the i^{-th} piece of lower-level content is contained in the copyright information acquired in step S804, for example.

(Step S807) The payment processing unit 136 performs processing for paying the payment amount acquired in step S805 to the author or the owner of the i^{-th} piece of lower-level content. The payment processing unit 136 performs processing for transferring the amount of money corresponding to the payment amount from the account of the author of the focused content to the account of the author or the owner of the i^{-th} piece of lower-level content, using the account information of the author or the owner of the i^{-th} piece of lower-level content contained in the copyright information acquired in step S804 and the account information of the author of the focused content contained in the copyright information corresponding to the focused content, for example.

(Step S808) The payment processing unit 136 determines whether or not there is even-lower-level content that was used to create the i^{-th} piece of lower-level content, using the copyright information acquired in step S804. If there is even-lower-level content, the procedure advances to step S809. Alternately, the procedure advances to step S810.

(Step S809) The payment processing unit 136 performs payment processing while taking the i^{-th} piece of lower-level content as the focused content. Accordingly, the payment processing is recursively performed.

(Step S810) The payment processing unit 136 increments the counter i by 1. The procedure returns to step S802.

Next, an example of the sales processing in step S333 will be described with reference to the flowchart in FIG. 9.

(Step S901) The processing unit 13 acquires an identifier contained in the sales instruction received in step S332. This identifier is an identifier of content that is to be sold.

(Step S902) The second identifier acquiring unit 133 acquires copyright information corresponding to the identifier acquired in step S901. The second identifier acquiring unit 133 acquires copyright information from any server 3 out of the two or more servers 3, for example.

(Step S903) The processing unit 13 acquires a user identifier of a new owner contained in the sales instruction received in step S332. The user identifier is contained in the sales instruction, for example. The processing unit 13 acquires owner information containing the user identifier. The owner information is information on a new owner. The owner information contains a user identifier, and is stored in the storage unit 11, the servers 3, or any other suitable apparatus (not shown).

(Step S904) The processing unit 13 acquires transfer date information indicating today's date, from a clock (not shown).

(Step S905) The processing unit 13 adds the owner information acquired in step S903 and the transfer date information acquired in step S904 to the copyright information acquired in step S902, thereby configuring new copyright information.

(Step S906) The management processing unit 135 registers the new copyright information configured in step S905. This registration is processing for accumulating information in the two or more servers 3, for example.

(Step S907) The payment processing unit 136 acquires fee information contained in the copyright information acquired in step S902.

(Step S908) The payment processing unit 136 performs processing for paying the amount of money indicated by the fee information acquired in step S907. The payment processing in this example is processing for the new owner to pay the amount of money to a previous owner of the sold content.

(Step S909) The payment processing unit 136 performs payment processing to the owner of the lower-level content that was used to configure the sold content. The procedure returns to the upper-level processing. This payment processing was described with reference to the flowchart in FIG. 8.

Next, an operation example of the terminal apparatus 2 will be described. If the terminal accepting unit 22 of the terminal apparatus 2 accepts an editing instruction, for example, the terminal processing unit 23 edits content according to the editing instruction.

Furthermore, if the terminal accepting unit 22 accepts an instruction for lower-level content, such as an acquisition instruction, an attribute value change instruction, or a change instruction, for example, the terminal transmitting unit 24 transmits this instruction to the information processing apparatus 1. As a result of the transmission of this instruction, the terminal receiving unit 25 receives an editing result or an error message from the information processing apparatus 1. Then, the terminal output unit 26 outputs the editing result or the error message.

Furthermore, if the terminal accepting unit 22 accepts a completion instruction, the terminal transmitting unit 24 transmits the completion instruction to the information processing apparatus 1. As a result of the transmission of this completion instruction, the created content is registered. The payment processing is performed for an author or an owner of the lower-level content that was used to create the content.

Furthermore, if the terminal accepting unit 22 accepts a sales instruction, the terminal transmitting unit 24 transmits the sales instruction to the information processing apparatus 1. Then, the information processing apparatus 1 performs sales processing of the content in response to the sales instruction.

Hereinafter, three examples of a specific operation of the information processing apparatus 1 will be described.

### SPECIFIC EXAMPLE 1

The editing unit 131 of the information processing apparatus 1 acquires an avatar that is primary content and clothing that is primary content, based on a received acquisition instruction, for example. Next, the editing unit 131 creates secondary content that is the avatar wearing the clothing, based on a received change instruction, for example. The editing unit 131 may change the color of the avatar, the color and size of the clothing, and the like, based on a received attribute value change instruction, for example.

Next, it is assumed that the operation information receiving unit 121 receives a completion instruction from the terminal apparatus 2. Then, the processing unit 13 configures copyright information of the created secondary content as follows. Therefore, the first identifier acquiring unit 132 acquires an identifier of the avatar that is the acquired primary content. The identifier of the avatar contains an ID of a blockchain in which the avatar is managed, for example. The first identifier acquiring unit 132 acquires an identifier of the clothing that is the acquired primary content. The identifier of the clothing contains an ID of a blockchain in which the clothing is managed, for example. The copyright information configuring unit 134 acquires copyright information corresponding to the identifier of the avatar. The copyright information configuring unit 134 acquires copyright information corresponding to the identifier of the clothing. The second identifier acquiring unit 133 creates a unique identifier of the created secondary content. The second identifier acquiring unit 133 configures an identifier containing a blockchain address and an ID of the created secondary content, for example. Next, the copyright information configuring unit 134 configures copyright information of the secondary content containing the identifier of the secondary content and part or the whole of the copyright information of the primary content. Next, the management processing unit 135 performs the above-described management processing for managing the created secondary content and the copyright information of the secondary content in association with each other.

### SPECIFIC EXAMPLE 2

The editing unit 131 of the information processing apparatus 1 acquires eyes that are primary content, hair that is primary content, and a skin texture that is primary content, based on a received acquisition instruction, for example. This primary content is referred to as “parts” below. Next, the editing unit 131 combines all of the acquired parts, thereby creating secondary content that is an avatar, based on a received change instruction, for example. The editing unit 131 may edit the parts based on a received editing instruction, and then combine the parts, thereby creating secondary content that is an avatar.

Next, it is assumed that the operation information receiving unit 121 receives a completion instruction from the terminal apparatus 2. Then, the processing unit 13 configures copyright information of the created secondary content as follows. Therefore, the first identifier acquiring unit 132 acquires identifiers of the parts that are the acquired primary content. The identifiers of the parts contain an ID of a blockchain in which the parts are managed, for example. The copyright information configuring unit 134 acquires copyright information corresponding to the identifiers of the parts. The second identifier acquiring unit 133 creates a unique identifier of the created secondary content. The second identifier acquiring unit 133 configures an identifier containing a blockchain address and an ID of the created secondary content, for example. Next, the copyright information configuring unit 134 configures copyright information of the secondary content containing the identifier of the secondary content and part or the whole of the copyright information of the primary content. Next, the management processing unit 135 performs the above-described management processing for managing the created secondary content and the copyright information of the secondary content in association with each other.

### SPECIFIC EXAMPLE 3

The editing unit 131 of the information processing apparatus 1 acquires two avatars that are primary content, based on a received acquisition instruction, for example. Next, the editing unit 131 swaps clothing worn by the two avatars, based on a received change instruction, for example. The editing unit 131 removes a watch from one avatar and adds it to the other avatar, based on a received change instruction, for example. It is assumed that two pieces of new secondary content are created through the above-described editing processing.

Next, it is assumed that the operation information receiving unit 121 receives a completion instruction from the terminal apparatus 2. Then, the processing unit 13 configures copyright information of the two pieces of created secondary content as follows. Therefore, the first identifier acquiring unit 132 acquires identifiers of the two avatars. The first identifier acquiring unit 132 acquires IDs (part IDs) of the swapped clothing and the watch of the avatars. The copyright information configuring unit 134 acquires copyright information corresponding to the identifiers of the avatars. The second identifier acquiring unit 133 creates unique identifiers of the two pieces of created secondary content. The second identifier acquiring unit 133 configures two different identifiers each containing a blockchain address and an ID of the created secondary content, for example. Next, for each piece of the created secondary content, the copyright information configuring unit 134 configures copyright information of the secondary content containing the identifier of the secondary content and part or the whole of the copyright information of the primary content. Next, the management processing unit 135 performs the above-described management processing for managing each of the two pieces of created secondary content and the copyright information of the secondary content in association with each other.

As described above, according to this embodiment, it is possible to provide a mechanism for properly managing a relationship between secondary content and primary content from which the secondary content was created.

Furthermore, according to this embodiment, it is possible to provide a mechanism for properly managing a relationship between secondary content and primary content from which the secondary content was created, using a non-fungible token.

Furthermore, according to this embodiment, the relationship between secondary content and primary content from which the secondary content was created is properly managed, and thus it is possible to pay a proper fee to an author or an owner of the primary content that was used to create the secondary content.

Furthermore, according to this embodiment, it is possible to properly distribute the fee for the sale of the secondary content.

Furthermore, according to this embodiment, the relationship between secondary content and primary content from which the secondary content was created is properly managed, and thus it is possible to pay a more proper fee to an author or an owner for the sale of the secondary content.

Furthermore, according to this embodiment, it is possible to properly use content by managing editability conditions according to the content.

The processing in this embodiment may be realized by software. The software may be distributed by software downloads or any other suitable method. Furthermore, the software may be distributed in a form where the software is stored in a storage medium such as a CD-ROM. The same applies to other embodiments in this specification. The software that realizes the information processing apparatus 1 in this embodiment is the following sort of program. Specifically, this program is a program for causing a computer to function as: a first identifier acquiring unit that acquires one or more first identifiers for respectively identifying one or more pieces of primary content that were used to create secondary content created using one or more pieces of primary content; a second identifier acquiring unit that acquires a second identifier for identifying the secondary content; a copyright information configuring unit that configures hierarchical copyright information containing the one or more first identifiers acquired by the first identifier acquiring unit and the second identifier acquired by the second identifier acquiring unit; and a management processing unit that performs management processing for managing the hierarchical copyright information configured by the copyright information configuring unit in association with the secondary content.

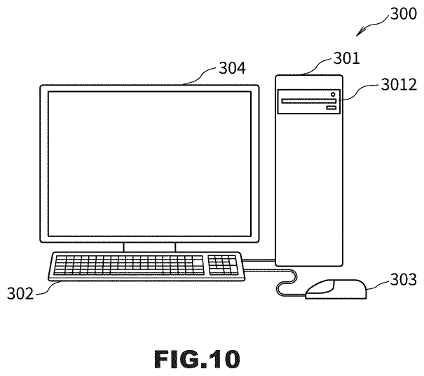

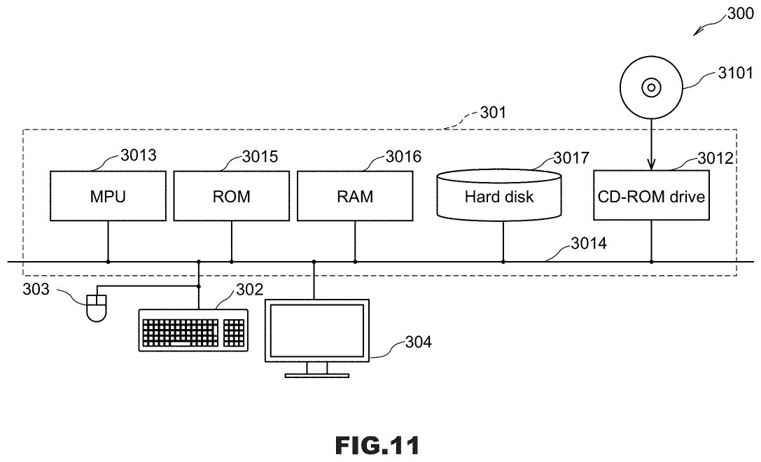

FIG. 10 shows the external appearance of a preferred computer that executes the program described in this specification to realize the information processing apparatus 1 of information system A, as described below in its various embodiments. The foregoing embodiments of information system A may be realized using computer hardware and a computer program executed thereon. FIG. 10 is a schematic view of a computer system 300. FIG. 11 is a block diagram of the system 300.

In FIG. 10, the computer system 300 includes a computer 301 including a compact disc read only memory (CD-ROM) drive, a computer keyboard 302, a computer mouse 303, and a computer monitor 304.

In FIG. 11, the computer 301 includes, in addition to the CD-ROM drive 3012, an MPU 3013, a bus 3014 connected to the CD-ROM drive 3012 or equivalent, a read-only memory unit (ROM) 3015 in which a program such as a boot up program is stored, a random access memory unit (RAM) 3016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a local area network (LAN).

The program for causing the computer system 300 to execute the functions of the information processing apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101. Alternately, the program may be loaded directly from a network.

The program does not necessarily have to include, for example, an operating system (OS) or a third party program to cause the computer 301 to execute the functions of the information processing apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed only by hardware is not included. For example, processing performed by a modem or an interface card in the transmitting step (processing that can be performed only by hardware) is not included.

Furthermore, the information processing apparatus that executes the program may consist of a single computer, or the information processing apparatus may consist of multiple computers. Therefore, centralized processing may be performed, or distributed processing may be performed, respectively.

Furthermore, in the foregoing embodiments, it will be appreciated that at least two communication elements in one apparatus may be physically realized by one medium.

In the foregoing embodiments, each process may be realized as centralized processing using a single information processing apparatus, or may be realized as distributed processing using multiple information processing apparatuses.

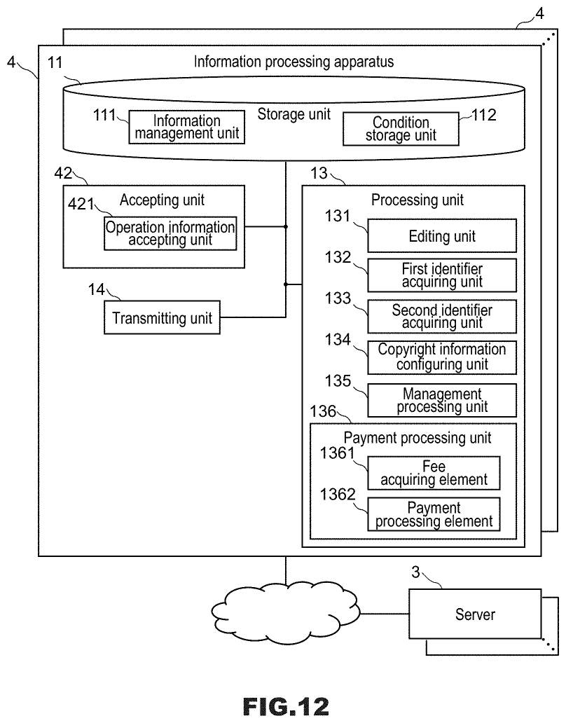

Therefore, the main function of the above-described information processing apparatus 1 may be realized by a terminal. FIG. 12 is a block diagram of an information processing apparatus 1 serving as such a terminal.

The information processing apparatus 1 includes the storage unit 11, an accepting unit 42, the processing unit 13, and the transmitting unit 14. The storage unit 11 includes the information management unit 111 and the condition storage unit 112. The accepting unit 42 includes an operation information accepting unit 421.

The accepting unit 42 accepts various types of information and instructions. The various types of information and instructions are operation information, one or more first identifiers, and fee information, for example. The accepting in this example is typically accepting information input from an input device such as a keyboard, a mouse, or a touch panel, but may be a concept that encompasses receiving information transmitted via a wired or wireless communication line, accepting information read from a storage medium such as an optical disk, a magnetic disk, or a semiconductor memory, and the like.

The operation information accepting unit 421 accepts operation information input by a user. The operation information is information on an operation regarding the secondary content. The operation information accepting unit 421 preferably accepts operation information associated with a user identifier.

Furthermore, the information processing apparatus 1 and each of the one or more P2P networks 3 can communicate with each other by means of a network such as the Internet 4.

Furthermore, the management processing unit 135 constituting the information processing apparatus 1 may transmit created content and copyright information corresponding to the content, or copyright information, to a server (not shown) not constituting blockchains that are the P2P networks 3. In this case, the content and the copyright information, or the copyright information is managed by the server. The management processing unit 135 may perform management processing (e.g., transmitting processing) for causing the content and the copyright information, or the copyright information to be managed in blockchains that are the P2P networks 3.

The present invention is not limited to the embodiment set forth herein. Various modifications are possible within the scope of the present invention.

### INDUSTRIAL APPLICABILITY

As described above, the information processing apparatus according to the present invention enables a mechanism for properly managing the relationship between a secondary creative work and a primary creative work from which the secondary creative work was created, thus rendering this apparatus useful as an information processing apparatus and the like.

### LIST OF REFERENCE NUMERALS

1 Information processing apparatus

2 Terminal apparatus

3 Server

4 Computer Network

11 Storage unit

12 Receiving unit

13 Processing unit

14 Transmitting unit

21 Terminal storage unit

22 Terminal accepting unit

23 Terminal processing unit

24 Terminal transmitting unit

25 Terminal receiving unit

26 Terminal output unit

111 Information management unit

112 Condition storage unit

121 Operation information receiving unit

131 Editing unit

132 First identifier acquiring unit

133 Second identifier acquiring unit

134 Copyright information configuring unit

135 Management processing unit

136 Payment processing unit

1361 Fee acquiring element

1362 Payment processing element

1. An information processing apparatus comprising a management processing unit for managing hierarchical copyright information comprising:
two or more first identifiers for respectively identifying two or more pieces of primary content that were used to create secondary content created using the two or more pieces of primary content; and
a second identifier for identifying the secondary content, associated with the secondary content.

2. The information processing apparatus according to claim 1, wherein the hierarchical copyright information is a non-fungible token.

3. The information processing apparatus according to claim 1, further comprising:
an operation information receiving unit that receives an editing instruction regarding two or more pieces of primary content that are used to create the secondary content; and
a payment processing unit that performs payment processing for paying a fee to one or more subjects among an author and an owner; and
said subjects corresponding to the first identifiers of the respective two or more pieces of primary content corresponding to the editing instruction received by the operation information receiving unit.

4. The information processing apparatus according to claim 1, further comprising:
an operation information receiving unit that receives a sales instruction to sell secondary content, the sales instruction corresponding to a second identifier for identifying the secondary content; and
a payment processing unit that acquires the second identifier corresponding to the sales instruction received by the operation information receiving unit, acquires two or more first identifiers that are paired with the second identifier, from the hierarchical copyright information corresponding to the second identifier, and performs payment processing for paying a fee to one or more subjects among an author and an owner corresponding to the two or more first identifiers and one or more subjects among an author and an owner corresponding to the second identifier.

5. The information processing apparatus according to claim 3, wherein the payment processing unit includes:
a fee acquiring element that acquires fees to the respective two or more subjects, using one or more of hierarchy information indicating whether the two or more subjects are subjects of the primary content or subjects of the secondary content, and degrees of contribution by the subjects in the secondary content; and
a payment processing element that performs payment processing using the fees to the respective two or more subjects acquired by the fee acquiring element.

6. The information processing apparatus according to claim 1, further comprising:
an editing unit that creates the secondary content in response to an editing instruction to create the secondary content using the two or more pieces of primary content,
wherein the editing unit refers to a condition storage unit in which editability conditions respectively associated with one or more pieces of primary content are stored, and creates the secondary content according to the editing instruction within a range allowed by the editability conditions respectively corresponding to the one or more pieces of primary content.

7. The information processing apparatus according to claim 6, wherein each of the editability conditions consists of one condition in a condition group including two or more of the conditions “use-as-is only”, “up to change of attribute value”, and “free”.

8. The information processing apparatus according to claim 6, wherein the fees for the two or more pieces of primary content differ according to the editing instruction.

9. The information processing apparatus according to claim 1, wherein the hierarchical copyright information contains author information for specifying an owner of an author's property right, transfer date information for specifying the date of transfer of the right, and fee information for specifying a fee at the time of transfer of the right.

10. The information processing apparatus according to claim 1, wherein the management processing unit registers the hierarchical copyright information in a blockchain in association with the secondary content.

11. An information processing method comprising a management processing step of managing hierarchical copyright information comprising:
two or more first identifiers for respectively identifying two or more pieces of primary content that were used to create secondary content created using the two or more pieces of primary content; and
a second identifier for identifying the secondary content, in association with the secondary content.

12. A method according to claim 11 in which the second identifier is an NFT.

13. A program for causing a computer to function as a management processing unit that performs management processing for managing hierarchical copyright information containing:
two or more first identifiers for respectively identifying two or more pieces of primary content that were used to create secondary content created using the two or more pieces of primary content; and
a second identifier for identifying the secondary content, in association with the secondary content.
